(19) United States
(12) Patent Application Publication
(10) Pub. No.: US 2019/0168250 A1
(43) Pub. Date: Jun. 6, 2019

(54) THIN FILM COATING SYSTEM

(71) Applicant: CHUNGHWA PICTURE TUBES, LTD., Taoyuan City (TW)

(72) Inventors: Yu-Hsien CHEN, Kaohsiung City (TW); Der-Chun WU, Taipei City (TW); Yen-Yu HUANG, Taoyuan City (TW)

(21) Appl. No.: 15/859,755

(22) Filed: Jan. 2, 2018

(30) Foreign Application Priority Data
Dec. 6, 2017 (CN) 201721677804.0

(51) Int. Cl. B05C 1/08

(52) U.S. Cl. CPC B05C 1/08

(57) ABSTRACT

A thin film coating system includes at least one first supporting roller, a coating device, and at least one drying device. The first supporting roller is configured to rotate based on a rotating central axis. The coating device has an opening. The opening of the coating device faces toward the first supporting roller. The coating device is configured to coat a flowable material toward the first supporting roller along a first direction through the opening. The drying device is located at a side of the rotating central axis adjacent to the coating device in the first direction and is configured to dry the flowable material.

### CROSS-REFERENCE TO RELATED APPLICATION

This application claims priority to CHINESE Application Serial Number 201721677804.0, filed Dec. 6, 2017, which is herein incorporated by reference.

### BACKGROUND

### Field of Invention

The present invention relates to a thin film coating system, and especially relates to a thin film coating system to which a flexible display is applied.

### Description of Related Art

In general, flexible electronic devices are manufactured by forming various elements on a flexible substrate or a conformal substrate of a plastic sheet and/or metal sheet. Materials used in the flexible electronic device include semiconductor materials such as amorphous silicon, low temperature polycrystalline silicon, and/or organic semiconductor material. In addition, materials used in printed electronics include thin-film silicon, inorganic or organic semiconductor to manufacture thin film transistors. The printed electronics may include roll to roll (R2R), a process that overcomes some of disadvantageous features found in silicon wafers, such as their non-soft nature, brittleness, or significantly large thickness.

### SUMMARY

The present disclosure provides a thin film coating system. The thin film coating system includes at least one first supporting roller, a coating device, and at least one drying device. The first supporting roller is configured to rotate based on a rotating central axis. The coating device has an opening. The opening of the coating device faces toward the first supporting roller. The coating device is configured to coat a flowable material toward the first supporting roller along a first direction through the opening. The drying device is located at a side of the rotating central axis adjacent to the coating device in the first direction and is configured to dry the flowable material.

In some embodiments of the present disclosure, the opening has a first width, and the drying device has a second width in an extending direction of the rotating central axis. The first width is greater than the second width.

In some embodiments of the present disclosure, the thin film coating system further includes at least one second supporting roller. The second supporting roller is located at a side of the rotating central axis away from the drying device in the first direction, and is configured to support a flexible substrate where the flowable material is coated thereon.

In some embodiments of the present disclosure, the flowable material is metal oxide.

In some embodiments of the present disclosure, the drying device includes an infrared drying device.

In some embodiments of the present disclosure, the opening of the coating device has a projection. The projection is projected on the first supporting roller along the first direction. The infrared drying device and the projection of the opening of the coating device are spaced apart by a distance in a range from about 1 mm to about 100 mm.

In some embodiments of the present disclosure, the drying device includes an exhaust device. The exhaust device of the drying device has at least one inlet and at least one outlet. The opening of the coating device has a first projection projected on the first supporting roller along the first direction. The exhaust device faces toward the first supporting roller along a second direction and has a second projection. The second projection is projected on the first supporting roller along the second direction. The second projection of the exhaust device covers the first projection of the opening of the coating device. The second direction intersects the first direction.

In some embodiments of the present disclosure, a number of the at least one outlets are plural. The outlets of the exhaust device are equidistantly arranged on the exhaust device along an extending direction of the rotating central axis.

In some embodiments of the present disclosure, the exhaust device and the first projection are spaced apart by a distance in a range from about 10 mm to about 50 mm.

In some embodiments of the present disclosure, the second direction is substantially perpendicular to the first direction.

In the aforementioned configurations, the flowable material can be uniformly formed on the flexible substrate in the thickness direction of the flexible substrate. Furthermore, since the thin film coating system includes a drying device, there is no need to rest the flowable material until the fluidity of the flowable material disappears for subsequent processes. However, the drying effect can be achieved immediately by the drying device at the time when the flowable material is coated on the flexible substrate. As such, the metal oxide solution may be used in a roll to roll (R2R) process, which may be also referred to as a continuous process.

### BRIEF DESCRIPTION OF THE DRAWINGS

FIG. 1 is a perspective view of a thin film coating system and a flexible display in accordance with some embodiments of the present disclosure;

FIG. 2 is a cross-sectional view of a thin film coating system and a flexible display in accordance with some embodiments of the present disclosure;

FIG. 3 is a perspective view of a thin film coating system and a flexible display in accordance with some other embodiments of the present disclosure; and

FIG. 4 is a cross-sectional view of a thin film coating system and a flexible display in accordance with some other embodiments of the present disclosure.

### DETAILED DESCRIPTION

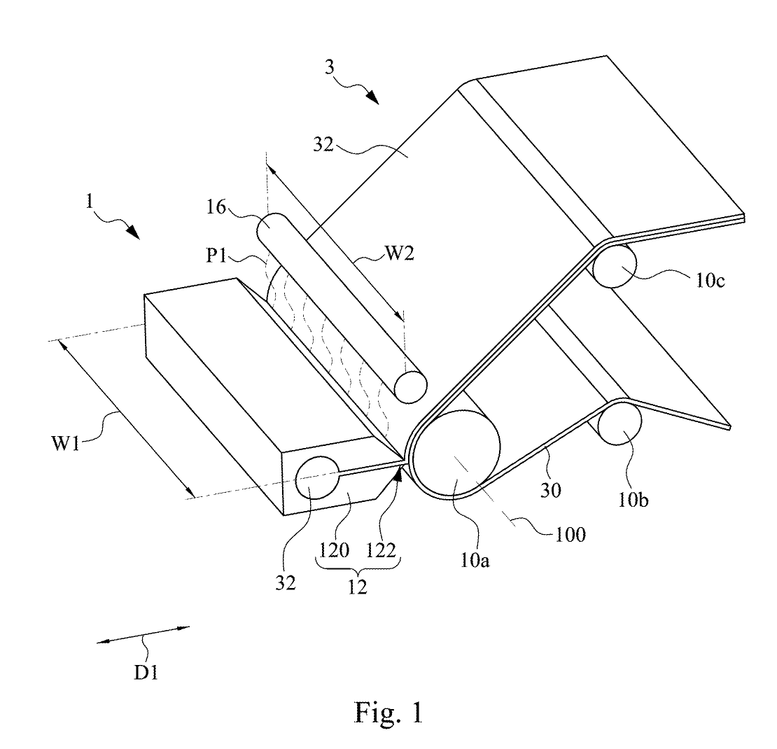

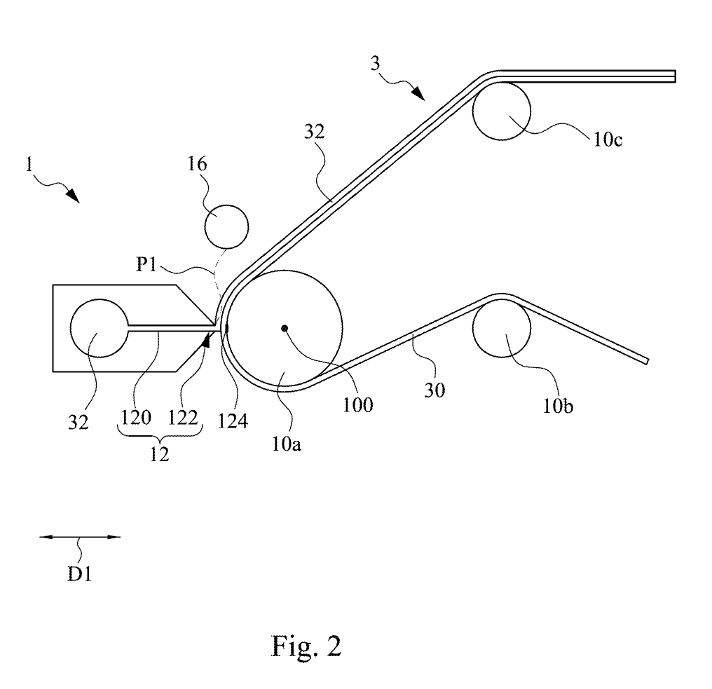

Reference is made to FIG. 1 and FIG. 2. FIG. 1 is perspective view of a thin film coating system 1 and a flexible display 3 in accordance with some embodiments of the present disclosure. FIG. 2 is a cross-sectional view of the thin film coating system 1 and the flexible display 3 in accordance with some embodiments of the present disclosure. As shown in the figure, in the embodiment, the thin film coating system 1 includes at least one supporting roller (depicted as three, i.e., a first supporting roller 10a, a second supporting roller 10b, and a third supporting roller 10c), a coating device 12, and at least one infrared drying device (IR heater) 16 (depicted as one). In the embodiment, the infrared drying device 16 is used as a drying device, but the present disclosure is not limited thereto. In some embodiments, any device that can be used to dry a flowable material 32 can be used in the present disclosure.

As shown in FIG. 1 and FIG. 2, the first supporting roller 10a is configured to rotate based on a rotating central axis 100. The second supporting roller 10b and the third supporting roller 10c are located at a side of the rotating central axis 100 away from the coating device 12 and the infrared drying device 16. In the embodiment, a flexible substrate 30 is wound and attached to portions of outer surfaces of the first supporting roller 10a, the second supporting roller 10b, and the third supporting roller 10c, and are configured to rotate with the rotation of the first supporting roller 10a, thereby being wound around the portions of the outer surfaces of the first supporting roller 10a, the second supporting roller 10b, and the third supporting roller 10c. Specifically, a portion of the flexible substrate 30 is wound and attached to a portion of an outer surface of the second supporting roller 10b adjacent to the third supporting roller 10c. Then, another portion of the flexible substrate 30 is further wound and attached to a portion of an outer surface of the first supporting roller 10a away from the second supporting roller 10b and the third supporting roller 10c. Then, the other portion of the flexible substrate 30 is further wound and attached to a portion of an outer surface of the third supporting roller 10c away from the second supporting roller 10b.

In the embodiment, the flexible substrate 30 is a thin film. In some embodiments, the flexible substrate 30 is made by polyethylene terephthalate (PET), polytetrafluoroethylene (PTFE), copper (Cu), or any other suitable material.

In FIG. 1 and FIG. 2, the coating device 12 has a body portion 120 and an opening 122 formed on the body portion 120. The body portion 120 of the coating device 12 is housed the flowable material 32. The opening 122 of the coating device 12 faces toward the first supporting roller 10a and has a first width W1 (shown in FIG. 1) in an extending direction of the rotating central axis 100. The flowable material 32 is communicated with outside of the coating device 12 through the opening 122. In the embodiment, the opening 122 of the coating device 12 has a first projection 124 (shown in FIG. 2) projected on the first supporting roller 10a along a first direction D1. The coating device 12 is configured to coat the flowable material 32 toward the first supporting roller 10a along the first direction D1 through the opening 122.

As such, as shown in FIG. 2, the flexible substrate 30 is driven clockwise by the first supporting roller 10a and is wound around portions of out surfaces of the first supporting roller 10a, the second supporting roller 10b, and the third supporting roller 10c as the first supporting roller 10a rotates clockwise. Under the foregoing operation, the portion of the flexible substrate 30 that passes through the first projection 124 (see FIG. 2) is coated with the flowable material 32.

In the embodiment, the infrared drying device is located at a side of the rotating central axis 100 adjacent to the coating device 12 along the first direction D1. That is, the infrared drying device 16 is located at a side of the rotating central axis 100 away from the second supporting roller 10b and the third supporting roller 10c. The infrared drying device 16 has a second width W2 (shown in FIG. 1) in the extending direction of the rotating central axis 100, and is configured to dry the flowable material 32. In the embodiment, the second width W2 of the infrared drying device 16 is greater than the first width W1 of the opening 122 of the coating device 12, so as to ensure that the range of the infrared drying device 16 being able to cover the area where the flowable material 32 is coated. In the embodiment, the infrared drying device 16 and the first projection 124 (see FIG. 2) of the opening 122 are spaced apart by a distance in a range from about 1 mm to about 100 mm, but the present disclosure is not limited thereto.

In the embodiment, the infrared drying device 16 utilizes radiation for thermal conduction and thus heats and dries the flowable material 32. Furthermore, the infrared drying device 16 of the present embodiment is able to uniformly heat the flowable material 32 so that the degree of drying of the flowable material 32 in different positions may be uniform, thereby ensuring the stability of the flexible display 3. For example, the infrared drying device 16 of the present embodiment may be a ceramic heater. The ceramic heater may include a ceramic tube and a resistive material combined with the ceramic tube. The symmetrical axis of the infrared drying device 16 is parallel to the rotating central axis 100. After the ceramic heater is turned on, the ceramic tube of the of the ceramic heater absorbs visible and/or infrared light radiated by the resistive material, thereby enabling temperature of the ceramic tube to increase, so as to produce vibrations to form pure silicon-oxygen bond molecules to radiate far-infrared rays, and thereby heating and drying the flowable material 32.

In practical application, the power used by the infrared drying device 16 may be in a range from about 50 Watts (W) to about 2000 Watts, and the voltage of the power thereof may be in a range from about 12 volts (V) to about 380 volts, but the present disclosure is not limited thereto.

The temperature of the infrared drying device 16 of the present embodiment may be controlled by changing the voltage of the power supply. As such, the infrared drying device 16 has good control over the heating temperature of the flowable material 32. In addition, the infrared heating device 16 has good penetration on the flowable material 32, so as to be able to heat the interior and exterior of the flowable material 32 simultaneously, and may heat the flowable material 32 locally to save energy.

In the embodiment, the flowable material 32 is made by metal oxide. In some embodiments, the flowable material 32 may be transparent oxide semiconductor. Since the metal oxide solution has low viscosity and good fluidity, the metal oxide solution can be uniformly formed on the flexible substrate 30 in the thickness direction of the flexible substrate 30. Furthermore, since the thin film coating system 1 includes infrared drying device 16, there is no need to rest the metal oxide solution until the fluidity of the metal oxide solution disappears for subsequent processes. However, the drying effect can be achieved immediately by the infrared drying device 16 at the time when the flowable material 32 is coated on the flexible substrate 30.

That is, with the foregoing configuration, after the coated flowable material 32 is driven by the flexible substrate 30 to leave the range of the first projection 124 (see FIG. 2), the flowable material 32 is substantially dried by the infrared drying device 16 and loses of fluidity thereof, so the flexible display 3 can be directly connected to a next process. As such, the metal oxide solution may be used in a roll to roll (R2R) process which may be also referred to as a continuous process.

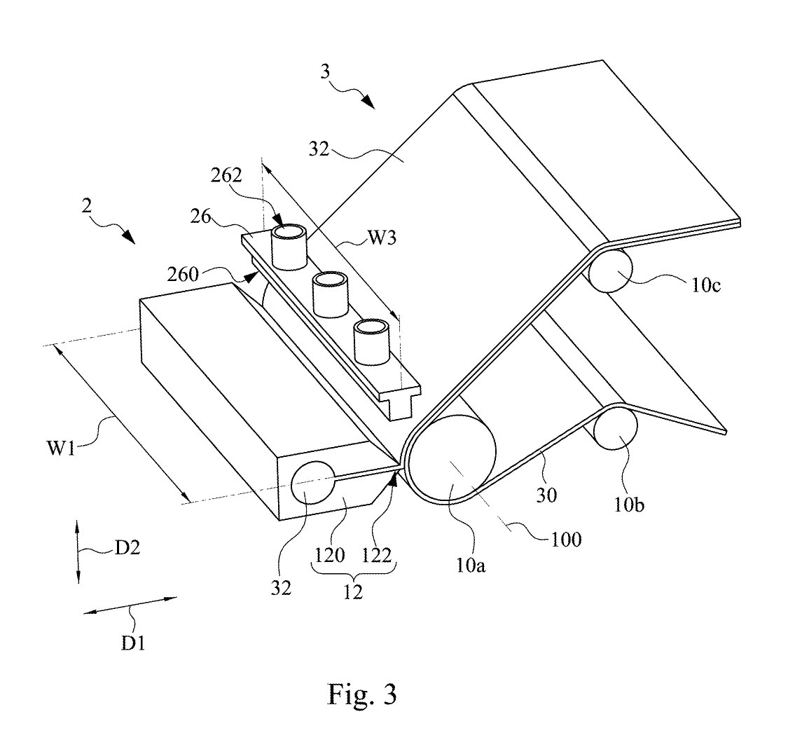

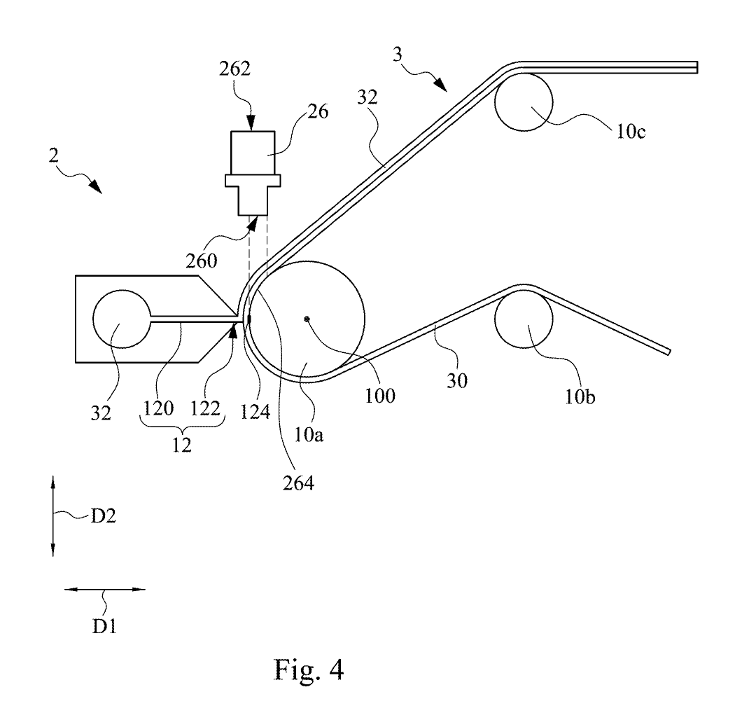

Reference is made to FIG. 3 and FIG. 4. FIG. 3 is a perspective view of a thin film coating system 2 and the flexible display 3 in accordance with some other embodiments of the present disclosure. FIG. 4 is a cross-sectional view of the thin film coating system 2 and the flexible display 3 in accordance with some other embodiments of the present disclosure. Structures shown in FIG. 3 and FIG. 4 includes at least one supporting roller (depicted as three, i.e., a first supporting roller 10a, a second supporting roller 10b, and a third supporting roller 10c), a coating device 12, and at least one exhaust device 26 (depicted as one). The structure and function of the components and their relationships are substantially the same as the structure shown in FIG. 1 and FIG. 2, and the related detailed descriptions may refer to the foregoing paragraphs, and are not described again herein. It is noted that, the difference between the present embodiment and the embodiment in FIG. 1 and FIG. 2 is in that the exhaust device 26 is used as the drying device instead of the infrared drying device 16 shown in FIG. 1 and FIG. 2, but the present disclosure is not limited thereto. In some embodiments, any device that can be used to dry the flowable material 32 can be used in the present disclosure.

As shown in FIG. 3 and FIG. 4, the exhaust device 26 has at least one inlet 260 (depicted as one) and least one outlet 262 (depicted as three). The exhaust device 26 is located at a side of the rotating central axis 100 adjacent to the coating device 12 along the first direction D1. The inlet 260 of the exhaust device 26 has a third width W3 (shown in FIG. 3) in the extending direction of the rotating central axis 100, and is configured to dry the flowable material 32. In the embodiment, the third width W3 of the exhaust device 26 is greater than the first width W1 of the opening 122 of the coating device 12 (see FIG. 3), so as to ensure that the range of the exhaust device 26 being able to cover the area where the flowable material 32 is coated.

In the embodiment, the inlet 260 of the exhaust device 26 faces toward the first projection 124 of the opening 122, and has a second projection 264 shown in FIG. 4) projected on the first supporting roller 10a along a second direction D2. The second projection 264 of the exhaust device 26 covers the first projection 124 (shown in FIG. 4) of the opening 122 on the first supporting roller 10a. In some embodiments, the second direction D2 intersects the first direction D1. In the embodiment, the second direction D2 is substantially perpendicular to the first direction D1.

The outlets 262 of the exhaust device 26 are equidistantly arranged on the exhaust device 26 along an extending direction of the rotating central axis 100, so as to stabilize the pumping speed of the exhaust device 26 in the extending direction of the rotation center axis 100, so that the exhaust device 26 is able to uniformly dry the flowable material 32. In the embodiment, the exhaust device 26 and the first projection 124 of the opening 122 are spaced apart by a distance in a range from about 10 mm to about 50 mm, but the present disclosure is not limited thereto.

In some embodiments, the infrared drying device 16 shown in FIG. 1 and FIG. 2 may be able to be further disposed at a side of the rotating central axis 100 adjacent to the coating device 12 along the first direction D1 in the thin film coating system 2 to increase the drying rate of the flowable material 32. In some embodiments, any device that can be used to dry a flowable material 32 may be able to use in the film coating system 2 at the same time. Similarly, in some embodiments, any device that can be used to dry a flowable material 32 may be able to use in the film coating system 1 shown in FIG. 1 and FIG. 2 at the same time.

According to the foregoing embodiments of the disclosure, it can be seen that, the flowable material can be uniformly formed on the flexible substrate in the thickness direction of the flexible substrate. Furthermore, since the thin film coating system includes drying device, there is no need to rest the flowable material until the fluidity of the flowable material disappears for subsequent processes. However, the drying effect can be achieved immediately by the drying device at the time when the flowable material is coated on the flexible substrate. As such, the metal oxide solution may be used in a roll to roll (R2R) process which may be also referred to as a continuous process.

What is claimed is:

1. A thin film coating system, comprising:
at least one first supporting roller configured to rotate based on a rotating central axis;
a coating device having an opening, the opening facing toward the first supporting roller, wherein the coating device is configured to coat a flowable material toward the first supporting roller along a first direction through the opening; and
at least one drying device located at a side of the rotating central axis adjacent to the coating device in the first direction and configured to dry the flowable material.

2. The thin film coating system of claim 1, wherein the opening has a first width and the drying device has a second width in an extending direction of the rotating central axis, and the first width is greater than the second width.

3. The thin film coating system of claim 1, further comprising at least one second supporting roller located at a side of the rotating central axis away from the drying device in the first direction and configured to support a flexible substrate where the flowable material is coated thereon.

4. The thin film coating system of claim 1, wherein the flowable material is metal oxide.

5. The thin film coating system of claim 1, wherein the drying device comprises an infrared drying device.

6. The thin film coating system of claim 5, wherein the opening of the coating device has a projection projected on the first supporting roller along the first direction, and the infrared drying device and the projection are spaced apart by a distance in a range from about 1 mm to about 100 mm.

7. The thin film coating system of claim 1, wherein the drying device comprises an exhaust device, the exhaust device has at least one inlet and at least one outlet, the opening of the coating device has a first projection projected on the first supporting roller along the first direction, the exhaust device faces toward the first supporting roller along a second direction and has a second projection projected on the first supporting roller along the second direction, the second projection covers the first projection, and the second direction intersects the first direction.

8. The thin film coating system of claim 7, wherein a number of the at least one outlet is plural, and the outlets are equidistantly arranged on the exhaust device along an extending direction of the rotating central axis.

9. The thin film coating system of claim 7, wherein the exhaust device and the first projection are spaced apart by a distance in a range from about 10 mm to about 50 mm.

10. The thin film coating system of claim 7, wherein the second direction is substantially perpendicular to the first direction.
